(19) United States
(12) Patent Application Publication
(10) Pub. No.: US 2011/0119977 A1
(43) Pub. Date: May 26, 2011

(54) SYSTEM FOR DISPLAYING RIVAL SPORTS TEAM

(76) Inventors: Adam Christopher Kays, Springfield, IL (US); Dan Seman, Sherman, IL (US)

(21) Appl. No.: 12/778,104

(22) Filed: May 11, 2010

Related U.S. Application Data
(60) Provisional application No. 61/264,028, filed on Nov. 24, 2009.

(51) Int. Cl. G09F 3/10

(52) U.S. Cl. 40/638

(57) ABSTRACT

The invention relates to a novel system for sports enthusiasts for displaying rival sports teams' logos by positioning the logo of a rival sports team low in the bowl of a toilet, urinal, sink, bath tub, or shower basin.

### RELATED APPLICATIONS

The present application claims priority from the U.S. provisional application No. 61/264,028, filed on Nov. 24, 2009 with the same inventors.

The present invention relates to a novel system for sports enthusiasts for displaying rival sports teams' logos by positioning the logo of a rival sports team low in the bowl of a toilet, urinal, sink, bath tub, or shower basin.

### BACKGROUND OF THE INVENTION

Sports enthusiasts have long sought novel ways to express loyalty to their teams through displaying logo-bearing flags, pennants, and other paraphernalia at sports events, in the home, in the car, or various other locations. The advent of formal licensing programs by sports teams at all levels of competition, both amateur and professional, along with the increased following of team sports by the general population, has resulted in increased popularity of such products. In addition to showing loyalty to their own teams, sports enthusiasts also show their great dislike of rival sports teams by displaying the rival team's logos in compromising positions and places.

The present invention allows the sports enthusiast to truly show their dislike for a rival sports team by positioning the logo of the rival sports team low in the bowl of a toilet, urinal, sink or bath tub directly above the outlet thereby allowing the enthusiast to relieve him or herself or wash him or herself over the logo of a rival team.

### SUMMARY OF THE INVENTION

The present invention teaches a novel system for sports enthusiasts for displaying rival sports teams' logos by positioning the logo of a rival sports team low in the bowl of a toilet, urinal, sink, bath tub, or shower basin and which will not have to be removed or rendered inoperative when the toilet, urinal, sink or bath tub is cleaned or used for purposes other than urination, washing or bathing.

The present invention teaches a system for the placement of a logo in a form which can be kept submerged in the toilet, bowl, sink, bath tub, or shower basin and will not be affected by either the flushing fluid or the urine or other substances commonly found to be flushed in toilets or urinals.

### DESCRIPTION OF THE INVENTION

The system is comprised of a logo and an adhesive that will be applied by the user to the logo to act as both an adhesive to the destined receptacle of the logo and a coating for the logo.

The logo is formed from a picture of arrival team's logo, name, trademark, service mark, an animal, or any other graphic representation, formed on paper, cardboard or any other suitable intermediate material. The logo may be formed of a suitable waterproof material which is formed into the desired shape and design. In a preferred embodiment, a coating encapsulates the logo.

An adhesive is provided to the user to apply to the logo for enabling the attachment of the logo to the receptacle. In a preferred embodiment, the adhesive and coating used is an aliphatic acrylic polyurethane which prevents the logo from cracking or yellowing over continued use.

The adhesive and the logo may be made of a variety of waterproof materials. Natural rubber, synthetic rubber, polyolefin, polyester and polyvinyl have been shown to be particularly suitable since they can take designs and colors. The materials chosen must have sufficient flexibility to take the shape of a surface curving in two or three dimensions.

In one embodiment, the adhesive is applied to the underside of the logo by the user. In a preferred embodiment, the adhesive is pre-applied to the underside of the logo.

The adhesive may be chosen from a wide variety of non-water soluble materials.

Acrylic based, rubber based, or synthetic rubber based or any combination of those three may be used with special effectiveness.

In particular the above adhesives may be used in combination with the previously listed materials for achieving a good combination in order to secure the logo to the receptacle.

Thus, a natural rubber, synthetic rubber, polyolefin, polyester or polyvinyl logo may have an adhesive which may be one or more of acrylic based, synthetic rubber based or rubber based. When these combinations of materials are used, the logo can only be removed by destroying or damaging it and can be said to be “non-removably” connected.

A “release paper” is attached to the adhesive which is removed to expose the adhesive just prior to affixing the logo to the bowl of the receptacle.

In one embodiment of the present invention, the rival team logo may be coated with a UV cold laminate or encapsulant so that the rival team logo may be waterproof when placed in the desired location. With such waterproof coating, the desired location needs to be simply dry prior to application of the rival team logo and then the user may simply affix the logo to the desired location.

The rival team logo can be disposed below the water line of the toilet and underneath the normal flow of water in a urinal. The rival team logo can also be disposed above or below the outlet of a bath tub or sink or shower basin outlet.

In an embodiment of the present invention, the logo may be formed from graphic representation of a flower, an animal, or any other graphic representation that can be used as home decor.

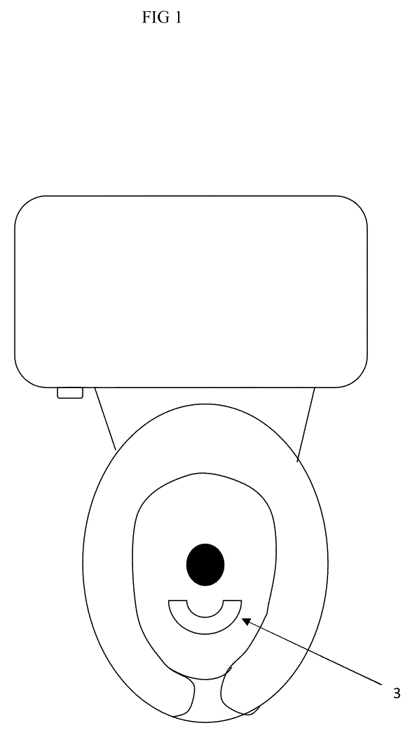

FIG. 1 shows a perspective view of the logo positioned the logo of a rival sports team low in the bowl of a toilet.

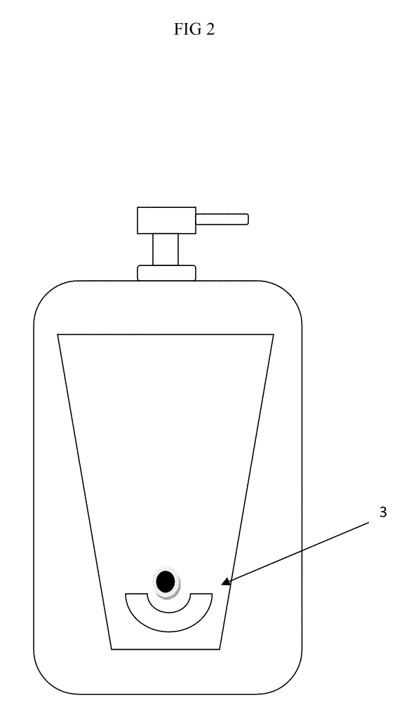

FIG. 2 illustrates the application of the logo positioned underneath the normal flow of water in a urinal.

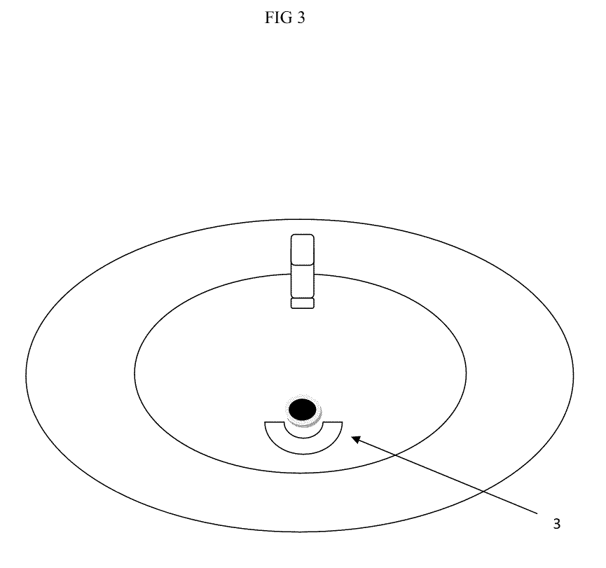

FIG. 3 illustrates the application of the logo positioned below the outlet of a sink

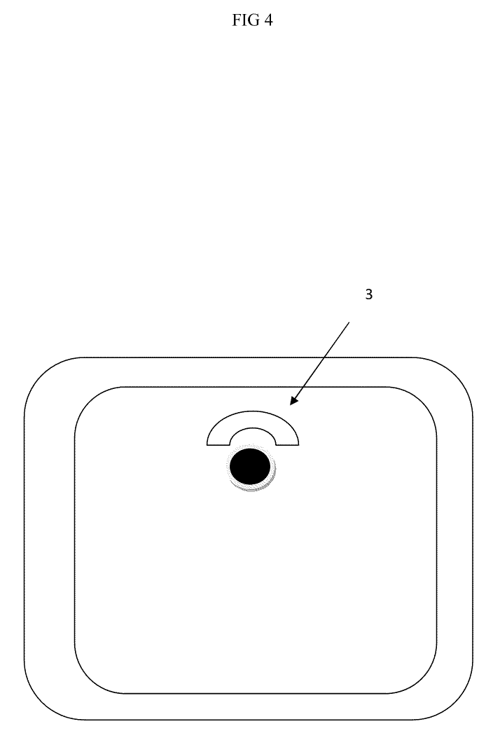

FIG. 4 illustrates the application of the logo positioned above the drain in the shower basin.

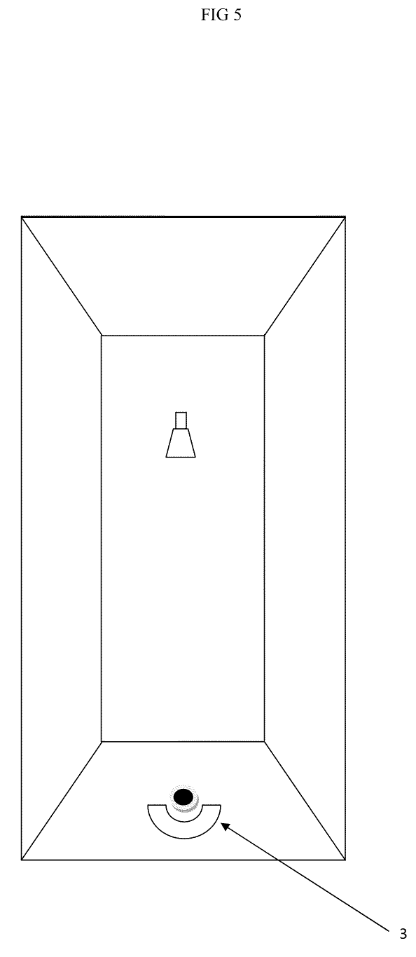

FIG. 5 illustrates the application below the outlet of a shower basin.

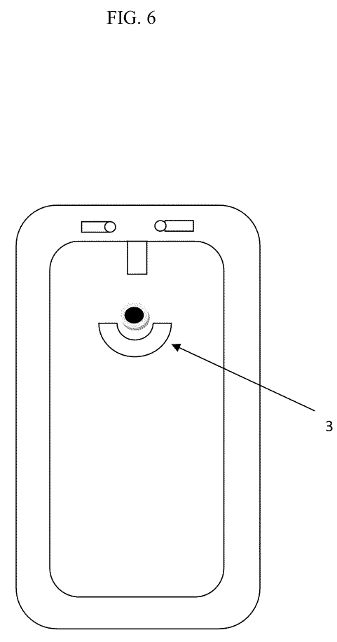

FIG. 6 illustrates the application below the outlet of a bath tub.

FIGS. 1, 2, 3, 4, 5 and 6, illustrate the placement of the logo in the desired locations. For example FIG. 1 illustrates the placement of the logo 3 low in the bowl of a toilet.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

We claim:

1. A system displaying rival sports teams' logos comprising:
a logo; and
an adhesive that is placed on the bottom side of the logo for adherence to a desired location.

2. A system according to claim 1 wherein the logo is adhered underneath the normal flow of water in a urinal.

3. A system according to claim 1 wherein the logo is adhered low in the bowl of a toilet.

4. A system according to claim 1 wherein the logo is adhered near the outlet of a sink.

5. A system according to claim 1 wherein the logo is adhered near the drain in the shower basin.

6. A system according to claim 1 wherein the logo is adhered near the outlet of a shower basin.

7. A system according to claim 1 wherein the logo is adhered near the outlet of a bath tub.

8. A system according to claim 1 wherein the adhesive is pre-applied to the underside of the logo.

9. A system according to claim 1 wherein the logo has a waterproof coating.

10. A method for displaying rival sports teams' logos comprising the steps of
a. Drying the desired location;
b. Applying logo with adhesive on underside of logo to desired location.

11. A method according to claim 10 wherein the desired location is underneath the normal flow of water in a urinal.

12. A method according to claim 10 wherein the desired location is low in the bowl of a toilet.

13. A method according to claim 10 wherein the desired location is near the outlet of a sink

14. A method according to claim 10 wherein the desired location is near drain in the shower basin.

15. A method according to claim 10 wherein the desired location is near the outlet of a sink

16. A method according to claim 10 wherein the desired location is near the outlet of a shower basin.

17. A method according to claim 10 wherein the desired location is near the outlet of a bath tub.
